(19) United States
(12) Patent Application Publication
(10) Pub. No.: US 2024/0277457 A1
(43) Pub. Date: Aug. 22, 2024

(54) Method for Producing an Interdental Cleaning Device, and Interdental Cleaning Device

(71) Applicant: LUORO GMBH, Köln (DE)

(72) Inventor: Louis Bahlmann, Köln (DE)

(21) Appl. No.: 17/790,529

(22) PCT Filed: Jan. 5, 2021
(86) PCT No.: PCT/EP2021/050090

§ 371 Date: Jul. 1, 2022

(30) Foreign Application Priority Data
Jan. 6, 2020 (DE) 10 2020 100 106.1

(51) Int. Cl. A61C 15/00

(52) U.S. Cl. CPC A61C 15/00; A46B 2200/108

(57) ABSTRACT

A method for producing an interdental cleaning device and an interdental cleaning device that includes a handle element and a brush element. The handle element is formed from a fibrous material, paper, or cardboard, and the brush element is connected to the handle element. For connecting the brush element to the handle element, a receiving portion of the handle element is arranged around a connecting portion of the brush element.

### CROSS-REFERENCE TO RELATED APPLICATIONS

This application is a US National Stage Entry of PCT/EP2021/050090 filed on Jan. 5, 2021, and which claims priority to DE 10 2020 100 106.1 filed on Jan. 6, 2020, all of which are hereby incorporated by reference herein for all purposes.

### FIELD

The present invention relates to a method for producing an interdental cleaning device comprising a handle element and a brush element, wherein the handle element is formed from a fibrous material, in particular from paper or cardboard. The invention relates further to an interdental cleaning device having a handle element and a brush element, wherein the handle element is formed from a fibrous material, in particular from paper or cardboard.

### BACKGROUND

Such an interdental cleaning device is known from JP 6501926 B2, for example. That interdental cleaning device comprises a handle portion formed from paper, and a brush portion. In JP 6501926 B2 it is proposed to form the handle portion integrally with the brush portion. Although such integral production makes it possible to obtain a secure hold of the brush portion on the handle portion, the integral production requires a complex production process.

### SUMMARY

The object of the present invention is to make it possible to produce an interdental cleaning device with minimal outlay and a secure hold between the handle portion and the brush portion.

In order to achieve the object there is proposed a method for producing an interdental cleaning device comprising a handle element and a brush element, wherein the handle element is formed from a fibrous material, in particular from paper or cardboard, and the brush element is connected to the handle element, wherein, for connecting the brush element to the handle element, a receiving portion of the handle element is arranged around a connecting portion of the brush element.

In order to achieve the object there is further proposed an interdental cleaning device having a handle element and a brush element, wherein the handle element is formed from a fibrous material, in particular from paper or cardboard, and the brush element is connected to the handle element, wherein a receiving portion of the handle element is arranged around a connecting portion of the brush element.

According to the invention, a receiving portion of the handle element is arranged around a connecting portion of the brush element. This makes it possible to obtain a robust connection between the handle element and the brush element. In addition, it is possible to provide the brush element as a prefabricated component which is connected to the handle element to produce the interdental cleaning device, whereby the outlay for producing the interdental cleaning device can be reduced.

The connection between the handle element and the brush element is preferably so robust that it breaks only under the effect of a pull-out force of greater than 15 N.

The handle element and the brush element are formed as separate elements of the interdental cleaning device. The handle element and the brush element are preferably produced from different materials. While the handle element is formed from a fibrous material, in particular from paper or cardboard, the brush element can be formed from a material or a plurality of materials that do not comprise fibrous material.

The brush element can comprise, for example, a metal and/or a plastics material. The brush element preferably comprises a base and brushes arranged on the base. The connecting portion of the brush element is preferably part of the base, for example a front end of a rod-shaped base. The base of the brush element is preferably formed from a metal, for example from a metal wire, particularly preferably from a plastics-coated metal wire. Alternatively, the base can be formed from a plastics material, for example from polypropylene (PP) or a thermoplastic elastomer (TPE). The brushes can be formed from a polyamide (PA), in particular from polyamide 6.6 (nylon) or from polyamide 6 (Perlon®).

The handle element is preferably of rod-shaped form. The receiving portion of the handle element is preferably arranged at a front end of the rod-shaped handle element. The receiving portion preferably comprises an opening, in particular a blind hole or a through-hole, which is open at an end face of the rod-shaped handle element. An interdental cleaning device in which the brush element is arranged in alignment with the handle element can thereby be obtained.

An advantageous embodiment provides that the fibrous material, in particular paper, is rolled or wound up to form the handle element. The fibrous material is preferably wetted before and/or during rolling. Wetting preferably establishes a water content of greater than 15%, preferably of greater than 20%, particularly preferably of greater than 30%, in the fibrous material, whereby rolling of the paper can be facilitated. The water content is preferably defined as the gravimetric water content, in particular in accordance with standard ISO 11465. Alternatively or additionally, it can be provided that an adhesive is applied to the fibrous material before and/or during rolling. The adhesive can strengthen the cohesion of the rolled fibrous material. Further alternatively or additionally, it can be provided that the rolled fibrous material of the handle element is coated with an adhesive after it has been rolled. For rolling, the fibrous material can be in the form of a sheet or strip, in particular in the form of a sheet of paper or a strip of paper. The fibrous material is preferably pressed against a curved counter-surface and carried along by a conveyor device, for example a conveyor belt or a conveyor roller. The counter-surface is preferably arranged such that a distance between the counter-surface and the conveyor device, when seen in a conveying direction, becomes smaller. By means of this ever decreasing distance, a gap is formed, in which the fibrous material rolls up and forms a rod-shaped, rolled handle element.

An advantageous embodiment of the invention provides that, for simultaneously forming the handle element and the receiving portion of the handle element, the fibrous material of the handle element is rolled or wound around a winding shaft, in particular a virtual winding shaft, in such a manner that a cavity is formed along the winding shaft. For this purpose, the fibrous material can be rolled or wound around a winding body which occupies the space of the cavity and is removed after rolling.

According to an advantageous embodiment of the invention it is provided that the receiving portion of the handle element is produced by drilling before the brush element is connected to the handle element. An alternative, advantageous embodiment provides that the receiving portion of the handle element is produced by pushing in a mandrel before the brush element is connected to the handle element. As a result of the drilling or pushing in, a receiving portion with a blind hole can be obtained, into which the connecting portion of the brush element can be introduced. The blind hole preferably has a depth which corresponds to the length of the connecting portion of the brush element, so that the connecting portion can be introduced into the blind hole until it abuts a base of the blind hole. The blind hole preferably has a diameter in the range of from 0.3 mm to 3 mm, particularly preferably in the range of from 0.5 mm to 1 mm.

A preferred embodiment provides that, on connection of the brush element to the handle element, the receiving portion of the handle element is produced by pushing the connecting portion of the brush element into the handle element.

In this context, an embodiment has been found to be advantageous in which, during the pushing in of the mandrel or of the connecting portion of the brush element, the handle element has a water content of greater than 15%, preferably of greater than 20%, particularly preferably of greater than 30%. The water content is preferably defined as the gravimetric water content, in particular in accordance with standard ISO 11465.

An advantageous embodiment provides that, for simultaneously forming the handle element and connecting the brush element to the handle element, the fibrous material of the handle element is rolled or wound around the connecting portion of the brush element. It is thereby advantageous if the brush element, in particular the connecting portion of the brush element, is first fixed to the fibrous material, for example by means of an adhesive, and only then is the fibrous material rolled or wound around the connecting portion. The brush element can be held and optionally guided by means of a holding device, for example a robotic arm, during rolling or winding of the fibrous material.

According to an advantageous embodiment it is provided that, for simultaneously forming the handle element and connecting the brush element to the handle element, the connecting portion is arranged between a handle element upper part and a handle element lower part. The handle element upper part and/or the handle element lower part and/or the connecting portion of the brush element are preferably provided with an adhesive, for example an acrylate or glue, before they are connected. The handle element upper part is preferably in the form of a portion of a sheet-form upper-part element and the handle element lower part is in the form of a portion of a sheet-form lower-part element. The sheet-form upper-part element and/or the sheet-form lower-part element can be sheets of cardboard, for example. After connection to the brush element, the handle element upper part and the handle element lower part can be detached from, in particular punched out of, the respective upper-part element or lower-part element, in particular simultaneously.

In all the above-described preferred embodiments of the method according to the invention, it is advantageous if an adhesive is applied to the connecting portion of the brush element and/or to the handle element before the brush element is connected to the handle element. The adhesive preferably comprises an acrylate, for example is in the form of an aqueous solution of an acrylate. Alternatively, the adhesive can be a glue. Examples of preferred adhesives are Henkel LOCTITE® 4061 and Henkel LOCTITE® 406.

According to an advantageous embodiment of the method, for connecting the brush element to the handle element, the receiving portion of the handle element is pressed, in particular from multiple sides, against the connecting portion of the brush element. The cohesion between the handle element and the brush element can be improved by the pressing. In an embodiment in which an adhesive is applied to the connecting portion of the brush element and/or to the handle element, the amount of adhesive required can be reduced as a result of the pressing. The receiving portion of the handle element is preferably pressed against the connecting portion of the brush element from two sides, so that a pressed connecting portion with two substantially parallel surfaces is obtained. The pressed connecting portion can have the form of a plate. Alternatively, it is possible that the receiving portion of the handle element is pressed against the connecting portion of the brush element from more than two sides, so that a pressed connecting portion with a triangular, quadrangular, pentagonal or polygonal cross section or with an approximately circular cross section is obtained. A cross section of the pressed receiving portion is preferably reduced compared to a cross section of the handle element outside the receiving portion, i.e. in particular it has a smaller diameter.

On pressing of the receiving portion of the handle element, an imprint is preferably introduced into the surface of the handle element. The imprint can have a pattern of grooves and/or a logo, for example. By means of the imprint, the haptics of the handle element and/or the flexibility of the handle element can be adjusted. It is further possible by means of the imprint to apply to the handle element information about the manufacturer of the interdental cleaning device or about the size of the brush element.

In an embodiment of the method in which the receiving portion of the handle element is pressed in order to connect the brush element to the handle element, there can be provided in the connecting portion of the brush element an interlocking element, in particular one or more barbs, which is connected, in particular hooked, to the receiving portion by the pressing of the receiving portion. In the case of a connecting portion formed from a wire, the wire can be folded over or bent over to form an interlocking element before it is introduced into the receiving portion. In the case of a connecting portion formed from a wire, the wire can alternatively be twisted with another wire to form an interlocking element. An interlocking element in the form of a barb can thereby be formed by the further wire. Further alternatively, in the case of a connecting portion formed from a wire, the wire can be twisted with itself and folded over or bent over to form an interlocking element, in particular a barb. An advantageous embodiment of the method provides that an end of the handle element that is opposite the receiving portion is pressed. The end that is opposite the receiving portion is preferably pressed such that a scoop-like region of the handle element is obtained. Such a scoop-like region can be used as a massage portion. Alternatively or additionally, the end of the handle element that is opposite the receiving portion is pressed such that a roughened surface quality is produced. Such a surface can allow the gums to be massaged. It is further possible to apply a medicament, for example chlorhexidine (CHX) or a fluoride, with such a massage portion. Alternatively, the end that is opposite the receiving portion can be pressed such that the end tapers to a point, so that a toothpick portion is formed.

A colored fibrous material, for example a colored paper, is preferably used to form the handle element. Information about the manufacturer of the interdental cleaning device or about the size of the brush element can alternatively or additionally be introduced into the handle element via the color. Alternatively or additionally, the fibrous material, in particular paper, can be printed, for example with a pattern, a logo and/or marking.

According to an advantageous embodiment of the method according to the invention it is provided that the brush element is produced, in particular by means of a brush element production machine, and the brush element is connected to the handle element immediately after the brush element has been produced. In particular, no method step of collecting a plurality of brush elements which have been produced takes place between the method step of producing the brush element and the method step of connecting the brush element to the handle element. This procedure has the advantage that complex separation of brush elements which have been produced is not required, because the individual brush elements are each connected to a handle element immediately after they have been produced. The connection of the brush element to the handle element preferably takes place in the same machine as the production of the brush element, in particular in the same brush element production machine. Alternatively, it is preferred if the brush element production machine used to produce the brush element is coupled directly to a connection machine by means of which the brush element which has been produced is connected to a handle element. Coupling of the brush element production machine with the connection machine can take place via a conveyor device or a bridge or a hose.

An advantageous embodiment of the method according to the invention provides that, for connecting the brush element to the handle element, heat is introduced into the handle element, in particular into the receiving portion of the handle element. Alternatively or additionally, for connecting the brush element to the handle element, heat can be introduced into the brush element, in particular into the connecting portion of the brush element. Further alternatively or additionally, for connecting the brush element to the handle element, a tubular element can be arranged around the receiving portion of the handle element and the connecting portion of the brush element and heat can be introduced into the tubular element arranged around the receiving portion and the connecting portion. The tubular element is preferably deformed as a result of the action of heat and/or the tubular element fuses with the receiving region of the handle element and/or the connecting region of the handle element.

It is advantageous in this context if the heat is introduced by means of a heating device, in particular having one or more sealing jaws, which is in contact with the receiving portion and/or the connecting portion and/or the tubular element.

Alternatively, the heat can be introduced by means of hot air. Further alternatively, the heat can be introduced by means of ultrasound. When ultrasound is used, it is particularly advantageous if the receiving portion and/or the connecting portion and/or the tubular element are pressed simultaneously.

In an embodiment of the method according to the invention in which the fibrous material, in particular paper, is rolled to form the handle element, it is advantageous if the fibrous material is provided with a heat-sealable coating, in particular before the handle element is formed. For connecting the brush element to the handle element, heat is preferably introduced into the heat-sealable coating of the fibrous material. The fibrous material is particularly preferably provided with the heat-sealable coating only in a portion which, after rolling of the fibrous material, forms the receiving region of the handle element.

The above-described advantageous embodiments and features relating to the method for producing the interdental cleaning device can also be applied alone or in combination to the interdental cleaning device.

Further details, features and advantages of the invention will become apparent from the drawings and from the following description of preferred embodiments with reference to the drawings. The drawings show only exemplary embodiments of the invention which do not limit the inventive idea.

### BRIEF DESCRIPTION OF THE FIGURES

FIG. 1 shows an interdental cleaning device according to an exemplary embodiment of the invention in a schematic side view.

FIG. 2 shows the interdental cleaning device according to FIG. 1 in a schematic sectional view, wherein the receiving portion of the handle element is arranged around the connecting portion of the brush element.

FIG. 3 shows the interdental cleaning device according to FIG. 1 in a schematic sectional view, wherein the receiving portion of the handle element is pressed from multiple sides against the connecting portion of the brush element.

FIG. 4 shows the interdental cleaning device according to FIG. 3 in a schematic sectional view, after pressing is complete.

FIG. 5 shows a flow diagram of a first exemplary embodiment of a method according to the invention.

FIG. 6 shows a flow diagram of a second exemplary embodiment of a method according to the invention.

FIG. 7 shows a flow diagram of a third exemplary embodiment of a method according to the invention.

FIG. 8 shows a flow diagram of a fourth exemplary embodiment of a method according to the invention.

FIG. 9 shows a flow diagram of a fifth exemplary embodiment of a method according to the invention.

### DETAILED DESCRIPTION

In the various figures, the same parts are always provided with the same reference numerals and are therefore generally also each named or mentioned only once.

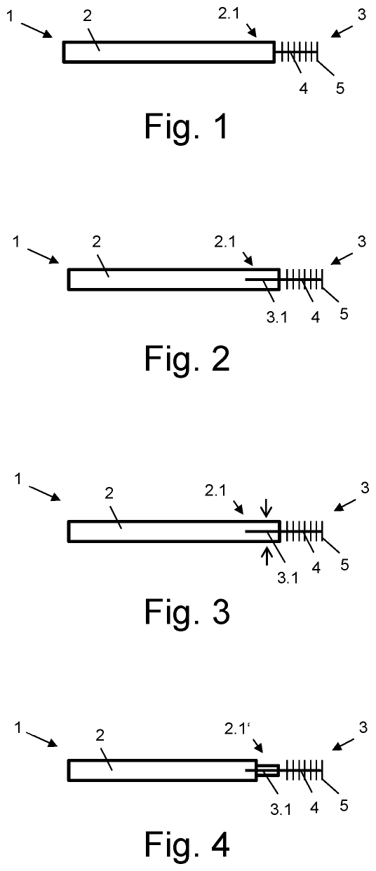

The illustrations in FIGS. 1 and 2 show an interdental cleaning device 1 according to an exemplary embodiment of the invention. The interdental cleaning device 1 comprises a handle element 2 which is formed form a fibrous material, in particular from paper or cardboard. A further component of the interdental cleaning device 1 is a brush element 3, which is connected to the handle element 2.

The handle element 2 has a cylindrical or rod-shaped form and is preferably formed from rolled or wound-up paper. At a first front end there is provided a receiving portion 2.1 in which the brush element 3 is received. In the exemplary embodiment, a second end of the handle element 2, which is arranged opposite the first end, is in the form of a free end with a substantially smooth end face. According to a modification of the exemplary embodiment it can be provided that there is provided at the second end a massage portion which has a shaping and/or surface quality which makes it possible to massage the gums using the massage portion. For this purpose, the second end can be scoop-like, for example, and/or can have a rough surface. A medicament, for example chlorhexidine (CHX) or a fluoride, can be applied with such a massage portion. Alternatively, a toothpick portion which tapers to a point can be provided at the second end.

The brush element 3 of the interdental cleaning device 1 consists of a base 4 and brushes 5 arranged on the base. In the exemplary embodiment, the base 4 is in the form of a straight wire, the main direction of extent of which is arranged parallel to a main axis of the handle element 2. The brushes 5 are inserted and/or woven into the base 4 and extend substantially perpendicular to the main direction of extent of the base 4. The brush element 3, in particular the base 4 of the brush element 3, has a connecting portion 3.1 around which the receiving portion 2.1 of the handle element 2 is arranged. By means of the connecting portion 3.1 and the receiving portion 2.1, the handle element 2 and the brush element 3 are connected together.

The illustration in FIG. 3 shows an exemplary embodiment of an interdental cleaning device 1 according to the invention during the production process, wherein the receiving portion 2.1 of the handle element 2 is pressed against the brush element 3, in particular against the base 4 of the brush element 3. Pressing of the receiving portion 2.1 can take place by means of a plurality of press jaws, for example two press jaws, which are moved towards one another. The press jaws can have a surface structure via which an engraving, for example a groove structure or a logo, is introduced into the surface of the receiving portion 2.1 during pressing.

FIG. 4 shows an interdental cleaning device which—as is shown in FIG. 3—has been treated by pressing. A pressed receiving portion 2.1′ has been produced by means of the pressing. The pressed receiving portion 2.1′ can have two substantially parallel surfaces. The pressed receiving portion 2.1′ has greater cohesion with the connecting portion 3.1 of the brush element 3 compared to a receiving portion 2.1 which has not been pressed.

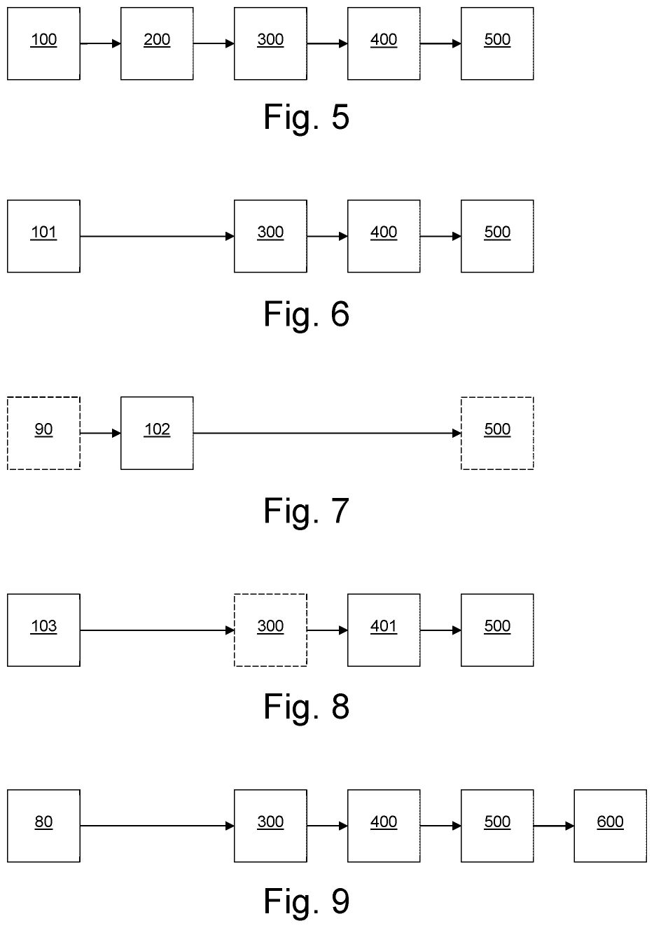

A number of exemplary embodiments of a method for producing an interdental cleaning device 1 comprising a handle element 2 and a brush element 3 will be described hereinbelow with reference to the illustrations in FIGS. 5 to 9, wherein the handle element 2 is formed from a fibrous material, in particular from paper or cardboard, and the brush element 3 is connected to the handle element 2. For connecting the brush element 3 to the handle element 2, a receiving portion 2.1 of the handle element 2 is arranged around a connecting portion 3.1 of the brush element 3.

FIG. 5 shows a flow diagram of a first exemplary embodiment of such a method for producing an interdental cleaning device 1. According to the first exemplary embodiment—in a method step of rolling 100—the handle element 2 is first formed by rolling or winding up the fibrous material. A substantially rod-shaped, cylindrical handle element 2 is obtained, which is configured in the manner of a shank. In a method step 200 following rolling 100, the receiving portion 2.1 of the handle element 2 is produced. This can be effected by drilling a blind hole into an end face of the handle element 2. Alternatively, the blind hole is produced by pushing a mandrel into the end face of the handle element 2. In this respect, in method step 200 a receiver for the brush element 3 is produced in the handle element 2.

In a method step 300, an adhesive is applied to the connecting portion 3.1 of the brush element 3, which in the further course of the method is to be connected to the receiving portion 2.1. Alternatively or additionally, the adhesive can be applied to the receiving portion 2.1.

In a method step of introduction 400, the receiving portion 2.1 of the handle element 2 is then arranged around the connecting portion 3.1 of the brush element 3. This can be effected, for example, by moving the connecting portion 3.1 of the brush element 3 in the direction towards the handle element 2 and introducing it into the receiving portion 2.1, in particular into the blind hole of the receiving portion 2.1. The connecting portion 3.1 introduced into the receiving portion 2.1 preferably fills the blind hole of the receiving portion 2.1 completely.

In a method step of pressing 500 which follows the introduction 400, the receiving portion 2.1 of the handle element 2 is pressed, in particular from multiple sides, against the connecting portion 3.1 of the brush element 3. Pressing 500 can be carried out as has been explained, for example, in connection with FIGS. 3 and 4.

FIG. 6 shows a flow diagram of a second exemplary embodiment of a method for producing an interdental cleaning device 1. In this exemplary embodiment—in a method step of rolling 101—the handle element 2 is first formed by rolling or winding up the fibrous material, wherein the fibrous material is rolled or wound around a winding shaft, in particular a virtual winding shaft, such that a cavity is formed along the winding shaft. In this respect, the handle element 2 and the receiving portion 2.1 of the handle element 2 are produced simultaneously in method step 101.

In a following method step of adhesive bonding 300, an adhesive is applied to the connecting portion 3.1 of the brush element 3. Alternatively or additionally, the adhesive can be applied to the receiving portion 2.1.

In a method step of introduction 400, the receiving portion 2.1 of the handle element 2 is then arranged around the connecting portion 3.1 of the brush element 3. This can be effected, for example, by moving the connecting portion 3.1 of the brush element 3 in the direction towards the handle element 2 and introducing it into the receiving portion 2.1, in particular into the blind hole of the receiving portion 2.1. The connecting portion 3.1 introduced into the receiving portion 2.1 preferably fills the blind hole of the receiving portion 2.1 completely.

In a method step of pressing 500 which follows the introduction 400, the receiving portion 2.1 of the handle element 2 is pressed, in particular from multiple sides, against the connecting portion 3.1 of the brush element 3. Pressing 500 can be carried out as has been explained, for example, in connection with FIGS. 3 and 4.

FIG. 7 shows a flow diagram of a third exemplary embodiment of a method for producing an interdental cleaning device 1. In this exemplary embodiment, the fibrous material of the handle element 2 is rolled around the connecting portion 3.1 of the brush element 3 so that the formation of the handle element 2 and the connection of the brush element 3 to the handle element 3 can take place simultaneously—that is to say in the same method step 102. Optionally, it can be provided that in a method step 90, before the method step of rolling 102, an adhesive is applied to the connecting portion 3.1 of the brush element 2 and/or to the fibrous material in order to fix the brush portion to the fibrous material and facilitate rolling or winding up.

During rolling 102 of the fibrous material around the connecting portion 3.1, the brush element 3 is held by a holding device, for example in the manner of a movable robotic arm. The holding device can change the position of the brush element 3 so that it can be guided along a counter-surface of a rolling or winding device during rolling 102 or winding of the fibrous material around the connecting portion 3.1. After the brush element 3 has been connected to the handle element 2 by rolling 102 of the fibrous material around the connecting portion 3.1, pressing 500 of the connecting portion 3.1 can optionally be carried out in order to further improve the cohesion of the brush element 3 and the handle element 2.

FIG. 8 shows a flow diagram of a fourth exemplary embodiment of a method for producing an interdental cleaning device 1. In this exemplary embodiment, the fibrous material, in particular paper, is first rolled in a method step of rolling 103 in order to form the handle element 2. The fibrous material is wetted before and/or during rolling so that a water content of greater than 15%, preferably of greater than 20%, particularly preferably of greater than 30%, is established in the fibrous material.

Immediately after rolling 103, that is to say in an undried state in which the water content in the fibrous material is greater than 15%, preferably greater than 20%, particularly preferably greater than 30%, the connecting portion 3.1 of the brush element 3 is pushed into the handle element 3 in a following method step of introduction 401, and the receiving portion 2.1 of the handle element 2 is thereby produced.

In a following method step of pressing 500, the receiving portion 2.1 of the handle element 2 is pressed, in particular from multiple sides, against the connecting portion 3.1 of the brush element 3. Pressing 500 can be carried out as has been explained, for example, in connection with FIGS. 3 and 4.

A method step 300 can optionally be provided, in which an adhesive is applied to the fibrous material and/or to the receiving portion 2.1 and/or to the connecting portion 3.1. Application of the adhesive can take place before and/or during and/or after the method step of rolling 103. The illustration in FIG. 8 shows optional application 300 of the adhesive after rolling 103 and before pushing 401 of the connecting portion 3.1 into the handle element 2.

FIG. 9 shows a fifth exemplary embodiment of a method for producing an interdental cleaning device 1. In this exemplary embodiment, a sheet-form upper-part element and a sheet-form lower-part element are first provided, see method step 80. A portion of the upper-part element forms a handle element upper part in the further course of the method and a portion of the lower-part element forms a handle element lower part in the further course of the method.

In a method step 300, an adhesive is applied to the upper-part element, in particular the handle element upper part, and/or to the lower-part element, in particular the handle element lower part, and/or to the connecting portion 3.1 of the brush element 3. Then, in a method step 400, the connecting portion 3.1 of the brush element 3 is introduced between the handle element upper part and the handle element lower part in order simultaneously to form the handle element 2 and an attachment portion 2.1 of the handle element 2 arranged around the connecting portion 3.1. The brush element 3 is thereby connected to the handle element 2.

In a following method step of pressing 500, the receiving portion 2.1 of the handle element 2 is pressed, in particular from multiple sides, against the connecting portion 3.1 of the brush element 3.

Finally, in a method step of separation 600 following pressing, the handle element 2, in particular the handle element upper part and the handle element lower part, are detached from the respective upper-part element or lower-part element. Detachment preferably takes place by punching.

In the production method according to the fifth exemplary embodiment, a plurality of interdental cleaning devices 1 can be produced simultaneously. For this purpose, in method step 300, the adhesive is applied to the upper-part element, in particular the handle element upper part, and/or to the lower-part element, in particular the handle element lower part, and/or to the connecting portion 3.1 of a plurality of brush elements 3. Then, in a method step 400, the connecting portions 3.1 of the plurality of brush elements 3 are introduced between the handle element upper part and the handle element lower part so as to simultaneously form a plurality of handle elements 2 and in each case an attachment portion 2.1 of the handle element 2 arranged around the connecting portion 3.1. The brush elements 3 are thereby connected to the handle elements 2. In the separation step, a plurality of handle elements 2 can be detached simultaneously or one after another from the respective upper-part element or lower-part element, for example by punching.

According to a modification of the fifth exemplary embodiment, separation 600 can be carried out before pressing 500 of the attachment portion 2.1.

In the above-described exemplary embodiments of the method according to the invention for producing an interdental cleaning device 1 it is preferably provided that the brush element 3 is produced in a brush element production machine and is connected to the handle element 2 immediately after it has been produced, so that it is possible to dispense with collecting brush elements 3 which have been produced and subsequently separating the collected brush elements 3.

In the above-described exemplary embodiments of the method according to the invention for producing an interdental cleaning device 1, heat can be introduced into the handle element 2, in particular into the receiving portion 2.1 of the handle element 2, and/or into the brush element 3, in particular into the connecting portion 3.1 of the brush element 3, in order to connect the brush element 3 to the handle element 2. Alternatively, it is possible, in order to connect the brush element 3 to the handle element, to arrange a tubular element around the receiving portion 2.1 of the handle element 2 and the connecting portion 3.1 of the brush element 3 and to introduce heat into the tubular element arranged around the receiving portion 2.1 and the connecting portion 3.1. For example, the fibrous material can be provided with a heat-sealable coating, in particular before the handle element 2 is formed, wherein, for connecting the brush element 3 to the handle element 2, heat is introduced into the heat-sealable coating of the fibrous material.

### LIST OF REFERENCE NUMERALS

1 interdental cleaning device
2 handle element
2.1 receiving portion
2.1′ pressed receiving portion
3 brush element
3.1 connecting portion
4 base
5 brushes
100, 101, 102 method step “rolling”
200 form blind hole
300 method step “application of an adhesive”
400, 401 method step “introduction”
500 method step “pressing”
600 method step “separation”

1. A method for producing an interdental cleaning device comprising a handle element and a brush element, wherein the handle element is formed from a fibrous material, paper, or cardboard, and the brush element is connected to the handle element, wherein, for connecting the brush element to the handle element, a receiving portion of the handle element is arranged around a connecting portion of the brush element.

2. The method as claimed in claim 1, wherein the brush element comprises a metal and/or a plastics material.

3. The method as claimed in claim 1, wherein the handle element is of rod-shaped form and the receiving portion of the handle element is arranged at a front end of the rod-shaped form of the handle element.

4. The method as claimed in claim 1, wherein the fibrous material or the paper, is rolled to form the handle element.

5. The method as claimed in claim 1, wherein for simultaneously forming the handle element and the receiving portion of the handle element, the fibrous material of the handle element is rolled or wound around a winding shaft, or a virtual winding shaft, in such a manner that a cavity is formed along the winding shaft.

6. The method as claimed in claim 1, wherein the receiving portion of the handle element is produced by drilling before the brush element is connected to the handle element.

7. The method as claimed in claim 1, wherein the receiving portion of the handle element is produced by pushing in a mandrel before the brush element is connected to the handle element.

8. The method as claimed in claim 1, wherein on the connecting of the brush element to the handle element, the receiving portion of the handle element is produced by pushing the connecting portion of the brush element into the handle element.

9. The method as claimed in claim 7, wherein during the pushing in of the mandrel or of the connecting portion of the brush element, the handle element has a water content of greater than 15%, or greater than 20%, or greater than 30%.

10. The method as claimed in claim 1, wherein for simultaneously forming the handle element and connecting the brush element to the handle element, the fibrous material of the handle element is rolled around the connecting portion of the brush element.

11. The method as claimed in claim 1, wherein for simultaneously forming the handle element and connecting the brush element to the handle element, the connecting portion is arranged between a handle element upper part and a handle element lower part.

12. The method as claimed in claim 1, wherein an adhesive is applied to the connecting portion of the brush element and/or to the handle element before the brush element is connected to the handle element.

13. The method as claimed in claim 1, wherein for connecting the brush element to the handle element, the receiving portion of the handle element is pressed from multiple sides, against the connecting portion of the brush element.

14. The method as claimed in claim 13, wherein on the pressing of the receiving portion of the handle element, an imprint is introduced into the surface of the handle element.

15. The method as claimed in claim 13, wherein the connecting portion of the brush element includes an interlocking element or one or more barbs, which is connected or hooked to the receiving portion by the pressing of the receiving portion.

16. The method as claimed in claim 1, wherein an end of the handle element that is opposite the receiving portion is pressed such that a roughened surface quality is produced and/or a scoop-like region of the handle element is obtained or the end tapers to a point.

17. The method as claimed in claim 1, wherein the brush element is produced by means of a brush element production machine, and the brush element is connected to the handle element immediately after the brush element has been produced.

18. The method as claimed in claim 1, wherein for connecting the brush element to the handle element, heat is introduced into the handle element or into the receiving portion of the handle element.

19. The method as claimed in claim 1, wherein for connecting the brush element to the handle element, heat is introduced into the brush element, or into the connecting portion of the brush element.

20. The method as claimed in claim 1, wherein for connecting the brush element to the handle element, a tubular element is arranged around the receiving portion of the handle element and the connecting portion of the brush element and heat is introduced into the tubular element arranged around the receiving portion and the connecting portion.

21. The method as claimed in claim 4, wherein the fibrous material is provided with a heat-sealable coating, before the handle element is formed, and wherein, for connecting the brush element to the handle element, heat is introduced into the heat-sealable coating of the fibrous material.

22. An interdental cleaning device having a handle element and a brush element, wherein the handle element is formed from a fibrous material, paper, or cardboard, and the brush element is connected to the handle element, wherein a receiving portion of the handle element is arranged around a connecting portion of the brush element.
